(19) United States
(12) Patent Application Publication
(10) Pub. No.: US 2008/0213329 A1
(43) Pub. Date: Sep. 4, 2008

(54) Method of Delivering a Biologically Active Agent

(75) Inventor: Ian Hamilton Baxter, Wiltshire (GB)

Correspondence Address: SENNIGER POWERS LLP, ONE METROPOLITAN SQUARE, 16TH FLOOR, ST LOUIS, MO, 63102, US

(73) Assignee: EXOSECT LIMITED, Winchester, Hampshire (GB)

(21) Appl. No.: 11/914,215

(22) PCT Filed: May 10, 2006
(86) PCT No.: PCT/GB2006/001698

§ 371 Date: Mar. 28, 2008

(30) Foreign Application Priority Data
May 12, 2005 (GB) 0509749.8

(51) Int. Cl. A01N 25/26; A01N 63/00

(52) U.S. Cl. 424/418; 424/421; 424/420; 424/419; 424/93.5

(57) ABSTRACT

A method of delivering a biologically active agent to a target site comprising exposing a surface of a non-target carrier organism to a carrier comprising at least one biologically active agent, wherein the non-target carrier organism delivers the biologically active agent to the target site.

The present invention relates to a method of delivering a biologically active agent to a target site through the use of a non-target carrier organism.

There are a number of known methods for controlling insect pests these include using pesticide sprays, mating disruption techniques, and attract and kill techniques using fixed dispenser and/or trap based systems.

Pesticide sprays suffer from the disadvantage that the aerosol droplets may drift and cause pesticides to contaminate non-target zones as well as the target crop. The application of such sprays also requires specialist equipment and training for the spray applicator. Furthermore, the widespread use of chemical pesticides in crop protection has led to the development of resistance to a wide range of pesticides in many species of insect, and the resistance continues to develop. It is desirable to develop new control measures that present fewer hazards to farmers, consumers and the environment, targeting the pest species effectively and minimising the amounts of pesticidal substances used.

To overcome these problems a number of different methods of insect control have been developed.

WO 94/00980 describes a method of controlling pests, such as insects, by trapping and/or killing them or preventing them mating effectively. The method involves the use of electrostatically charged particles which adhere to the insect cuticle. The particles may comprise a pesticide, or a behaviour modifying chemical.

WO 00/01236 describes a method of controlling pests, such as insects, by trapping and/or killing them or preventing them mating effectively, wherein the pest is exposed to a composition comprising particles containing or consisting of at least one magnetic material.

WO 99/60848 describes a method of controlling pests such as insects, by at least partially coating the pest with a particulate material incorporating a killing or behaviour modifying agent, which method comprises directing, attracting or otherwise luring the pest on to, above, or otherwise adjacent to a surface bearing such a particulate material to render the material airborne by the movement of the pest on, above, or in the region of the particulate material-bearing surface.

These prior art methods may involve mating disruption techniques. Mating disruption techniques involve the use of pheromone dispensers (Howse, Stevens & Jones: Insect pheromones and their role in pest management, Chapman & Hall 1998). The dispensers, which contain a sexual attractant pheromone, are placed in a crop where the pests exist. Numerous dispensers are needed to maintain the concentration of the pheromone high enough within the crop to interfere with the ability of male species to pick up wind-borne plumes of pheromone emitted by females of the same species.

This technique suffers from the disadvantage that the dispensers must be designed to hold and liberate relatively large amounts of pheromone continuously. Because pheromones in general are expensive to synthesise in view of the high degree of purity involved, the control technique is also expensive. In addition, dispensers commonly have to be deployed at an application rate of around 400-1000 per hectare, which is a costly and time-consuming process.

An alternative method of achieving mating disruption without using pheromone dispensers is the Sterile Insect Technique or SIT. This technique involves the mass release of sterilised insects into the natural population. Such techniques are well-known, as are the methods of rearing sterilised insects on an artificial diet, quality control, sterilisation, and release, all of which form part of this technique. This technique is operated by international agencies such as the International Atomic Energy Authority, and is used in the control of Mediterranean fruit flies, codling moths, pink bollworms, tsetse flies and other pests.

A disadvantage of this technique is that a large number of sterilised insects must be released into the natural population, so that the probability of a non-sterile female and male insect mating is very low compared to the probability of a non-sterile insect mating with a sterile insect.

Attract & kill techniques disclosed in the prior art require dispensers containing an attractant, such as a pheromone or a kairomone, and a pesticide. The target insect will be attracted to the dispenser where it comes into contact with the pesticide which has the effect of killing it. To make such systems efficacious, high quantities of pesticide are often required. Furthermore, it is an essential feature of such attract and kill techniques that there is an attractant, to lure the insect to the dispenser. Thus, such systems are only as good as the attractants utilized. These methods, therefore, are not suitable for controlling pests where there is no attractant available, or where the attractants are not particularly efficacious.

A further disadvantage of these techniques is that the dispensers are often required in large numbers. Preparing and hanging attract & kill dispensers is accordingly a costly and time consuming process.

It is an object of the present invention to overcome at least some of the problems and disadvantages of the prior art.

According to the present invention there is provided a method of delivering a biologically active agent to a target site comprising exposing a surface of a non-target carrier organism to a carrier comprising at least one biologically active agent, wherein the non-target carrier organism delivers the biologically active agent to the target site.

Included within the term “biologically active agent” are pesticides, behaviour modifying agents, plant nutrients, tracing agents and natural materials, such as pollen, or any combination thereof.

By the term “pesticide” as used herein is meant any substance which can be used in the control of agricultural, natural environmental and domestic pests, such as insects. These include, but are not limited to insecticides, herbicides, chemosterilants, anti-microbial agents, acaricides, ovicides, insect growth regulators, fungicides, fungi, viruses, bacteria, essential oils, anti-viral agents, bacteriacides or any combination thereof.

The term “essential oil” includes within its scope, but is not limited to, oil of thyme, oil of rosemary, cedarwood oil, camphor oil, camomile oil, thymol or any combination thereof.

By the term “herbicide” as used herein is meant any substance which can be used in agriculture to control or modify plant growth.

The term “behaviour modifying agent” includes within its scope, but is not limited to, semiochemicals such as natural and synthetic phermones, allomones, kairmones, parapheromones; allelochemicals and repellents or any combination thereof.

A semiochemical is a chemical that affects the behaviour of an organism. Semiochemicals used in communication between members of the same species are known as pheromones, and those involved in communication between members of different species are classed as allelochemicals. Allelochemicals may be involved, for example, in communication between different species of animals, or between plants and animals. Semiochemicals may be attractive or repellent, or have other effects on behaviour. Insect pheromones may be, for example, species-specific sex pheromones which can be used to interfere with mate-seeking, aggregation pheromones and alarm pheromones, which can be used to attract insects to baits.

The term “plant nutrient” as used herein includes within its scope, but is not limited to, plant stimulants, growth stimulants, plant tonics or any combination thereof.

The term “tracing agents” as used herein includes within its scope, but is not limited to, dyes and radioactive tracing agents.

The biologically active agent may be chosen to have a broad or narrow spectrum of action depending on the desired objective.

It will be apparent to the skilled person that two or more biologically active agents may be used in the method of the present invention.

By the term “non-target carrier organism” as used herein is meant an organism which is capable of delivering the biologically active agent to the target site.

The non-target carrier organism of the present invention may be an arthropod. Preferably, the arthropod is an insect. The insect may include pests encountered in agriculture, horticulture, forestry and public health. Such insects include (among others) ants and termites, lepidopteran pests (moths), flies (e.g. fruit flies, tsetse flies, biting flies, houseflies and mosquitoes), cockroaches and coleopteran pests (e.g. beetle pests of forestry plantations). Alternatively, the insect may not be a pest, but may be a beneficial insect, for example a bee.

The arthropod may be exposed to the biologically active agent prior to egg hatch; during egg hatch; at any larval stage; pre, during, post emergence from the pupa; or any combination thereof.

It will be understood that the non-target carrier organism may be attracted to dispensers containing biologically active agent, in for example a field, where the non-target carrier organism will be exposed to the biologically active agent. Alternatively, the non-target carrier organism may be exposed to the biologically active agent by passing through dispensers fitted to the entrance and/or exit of the non-target carrier organism's hive, honeycomb, nest, or place of habitation.

The target site of the present invention may be a target organism, for example, an arthropod, a plant, or it may be a discrete location, such as a field or a honeycomb at which the organism is found.

Preferably, the target organism is an arthropod. More preferably, the arthropod is an insect. It will be apparent that the insect may be a pest encountered in agriculture, horticulture, forestry and public health. Such insects include (among others) ants and termites, lepidopteran pests (moths), flies (e.g. fruit flies, tsetse flies, biting flies, houseflies and mosquitoes), cockroaches and coleopteran pests (e.g. beetle pests of forestry plantations). Alternatively, the target organism may be a parasite of the non-target carrier organism. Alternatively, the insect may not be a pest, but may be a beneficial insect, for example a bee.

The target organism of the present invention may be an organism of the same or different species as the non-target carrier organism. Preferably, the non-target carrier organism is unable to mate with and/or produce viable offspring through mating with the target organism. It will be understood that this may be through mating disruption, and/or because the carrier organism is sterile.

It will be apparent that the non-target carrier organism of the present invention may be sterile as a result of being reared on an artificial diet containing a sterilant, or lacking in certain nutrients required for potency; and/or radiation treatment; and/or chemical treatment; and/or genetic modification; and/or genetic factors. Such methods of sterilisation are known in the prior art.

It will be understood by those skilled in the art that a range of species of sterile insects may be used in the present invention, including, but not limited to, fruit flies, such as Mediterranean fruit fly (Ceratitis capitata), Anastrepha, Rhagoletis Toxotrypana or Bactrocera (Dacus) species; other insects, such as blowflies, tsetse flies, screwworms, or mosquitoes; Lepidoptera, such as codling moths, false codling moths (Cryptophlebia leucotreta), Lobesia, Epiphyas, Plutella, Chilo, and Helicoverpa species; and stored product pests, such as weevils.

The non-target carrier organism may be physiologically sterile. For example, the non-target carrier organisms may be social insects, such as honeybees, ants or wasps. The workers alone may be chosen, since they are physiologically sterile.

Alternatively, the target organism may be an organism of a different species to the non-target carrier organism. This may be desirable where the target organism is a parasite of the carrier, or the target site is, for example, a plant, or where it would not be desirable to introduce more pests to a particular location.

It will be apparent that when the non-target carrier organism is of the same or different species as the target organism the method of the present invention may be advantageous over prior art methods. For example, where the target organism cannot be attracted at all, or where insufficiently high numbers of target organisms can be attracted to a conventional dispenser holding biologically active agents, or where applying the biologically active agents directly to the target organisms would be too expensive or too labour-intensive, but where the behavior of the non-target carrier organism can be utilized to do deliver the biologically active agent to the target organism.

It will be understood that mating disruption is caused by the presence of a behaviour modifying chemical on the non-target carrier organism.

Mating disruption may be caused by the method of the present invention when the non-target carrier organisms are of a same species as the target organism. Unlike traditional methods of SIT, where it is only desirable to release male sterile insects, in the method of the present invention, where the insects carry pheromone, it is equally advantageous to release both female and male sterile insects into the wild. In this case, both the female and male insects can effectively compete with wild non-sterile female insects and thereby cause mating disruption.

A further example of mating disruption contemplated in this present invention is use of a behaviour modifying chemical on a non-target organism of a different species to the target organism wherein the behaviour modifying chemical may be specific to the target organism species. In this case, the target organism may be attracted to the non-target organism and so fail to mate with its own species to produce viable offspring due to competition from the non-target organism.

By the term “discrete location” as used herein is meant a location wherein the target organism lives, feeds, inhabits, or wherein it can be found. This may include for example, a field, a crop, a honeycomb, a nest, a plant, a hive, structural timbers, or a mound.

The term “carrier” as used herein describes any vehicle which is capable of retaining the biologically active agent thereon and capable of adhering to the non-target carrier organism so as to allow the biologically active agent to be delivered to the target site. Included within the scope of the term “carrier”, but not limited to, is a particle, a film, or a substrate.

The carrier may be capable of releasably adhering to the non-target carrier organism such that the carrier and the biologically active agent may be delivered to the target site. Alternatively the carrier may be retained on the non-target carrier organism and the biologically active agent may be released.

By the term “releasibly adheres” as used herein means any form of temporary attachment to the non-target carrier organism, for example, the attractive force may be electrostatic, magnetic (both temporary and permanent), chemical or physical.

The particles of the present invention may comprise silicon dioxide, magnesium silicate, diatomeous earth, cellulose, wax, lipids, resins, ceramics or a natural or synthetic polymer (such as chitin, chitosan or rubber) or any combination thereof. The active ingredients may be incorporated in the particle by methods including the use of solvents, or by adhering to the outside of the particles (as, for example, in the case of fungal spores or pollen).

Alternatively, the particle may be a composite particle comprising a core of inert substrate. By the term “inert” is meant a material which acts merely as a carrier for the biologically active agent. The inert substrate is preferably porous and highly absorbent. Suitable materials include those listed above for the particle. The inert substrate may have the biologically active agent associated with it by impregnation into it, or the biologically active agent may be, for example, adsorbed thereon or absorbed therein; and/or it may be coated with the biologically active agent. By the term “coated” as used herein includes a partial coating of the particle. Further, the biologically active agents may be incorporated in the particle using solvents, or may adhere to the outside of the particles (as, for example, in the case of fungal spores or pollen).

It will be understood that the particle size will depend on the particular non-target carrier organism used in a particular embodiment of the present invention. The particles may be milled down to a preferred size, range, weight or shape, such that they may detach more easily from the surface of the organism on contact. If the particles are too small then they may become hazardous to human health, whilst too large they will tend to fall off the non-target carrier organism before the non-target carrier organism reaches the target site.

Preferably, the particles have an average particle size diameter in the range of from 0.5 to 100 μm. More preferably, the particles have an average size diameter in range of 5 to 15 μm. Most preferably, the particles have an average size diameter in range of 10 to 12 μm.

The particle may comprises electrostatically charged materials or metallic materials.

Preferably, the particle comprises at least 0.01% by weight of biologically active agent. More preferably, the particle comprises at least 0.1% by weight of biologically active agent.

Where a chemical or naturally occurring insecticide or acaricide is used, the amount of biologically active agent associated with the particles will preferably range from 0.1 to 10% by weight. Where an entomopathogen is used, the quantity will preferably be greater, because of the size of the pathogenic organism involved, reaching up to 40% by weight. Where an essential oil is used, in order to ensure efficacy, the quantity will preferably be greater than 10% by weight. Wherein the essential oil is thymol, thymol will preferably be present in about 20% by weight. Where a semiochemical is used, the amount of material required to affect the behaviour of the organism when the particulate material is resting on the body surface may be extremely low in view of the extremely high sensitivity of insect chemical sense organs to certain semiochemicals. A semiochemical present in amounts from 0.1 femtograms per particle to 1 microgram per particle may affect behaviour, where the overall particle averages 0.1 to 50 micrometres.

In the method of the present invention the particle may be transferred from the non-target carrier organism to the target site. Alternatively, the biologically active agent may be transferred to the target site without transfer of the particle.

The present invention will further be illustrated by reference to a number of embodiments.

Each aspect as defined above may be combined with any other aspect or aspects unless clearly indicated to the contrary. In particular any feature indicated as being preferred or advantageous may be combined with any other feature or features indicated as being preferred or advantageous.

### EXAMPLE 1

In a first embodiment of the present invention, sterile insects are used as non-target carrier organisms of pheromone in order to create mating disruption in the same species of organism. The insects are coated with particles comprising species-specific sexual attractant pheromone produced by, for example the female of the target species. When the insects are released into a field at a density ranging from hundreds to many thousands per hectare, they act as attractant sources for the male species, outnumbering the females in the natural population, and decoying natural non-sterile males away from non-sterile females.

It will be understood that if the dose per individual insect is sufficiently high, and sufficient sterile insects are released, enough pheromone may be released into the atmosphere to raise the overall concentration above the threshold necessary to enhance mating disruption by saturation of the insects' sense organs (habituation). This will enhance the mating disruption engendered by false trail following. By using sterile insects as living delivery systems of pheromone, mating of males of the natural population is prevented, and the relatively few matings that may occur are likely to be between sterile males and females of the natural population, leading to sterile eggs.

### EXAMPLE 2

A second embodiment of the present invention uses sterile insects as non-target carrier organisms of pheromone. The pheromone is specific to a pest of a different (target) species than the carrier insect in order to create mating disruption in the target species. For example, where it is desired to control a pest such as a grape moth (Lobesia botrana) in a zone suitable for the survival of adult Mediterranean fruit flies (Ceratitis capitata or medflies), sterile medflies may be released coated with particles comprising the pheromone of the grape moth. The sterile medflies do not pose a threat to the crop concerned but they act as mobile delivery systems of grape moth pheromone decoying males away from females. They may flood the atmosphere with grape moth pheromone that will make location of the natural females more difficult. This again results in mating disruption which reduces the progeny of the grape moth.

### EXAMPLE 3

In a third embodiment of the present invention, sterile insects of the same species are used as non-target carrier insects. For example, to control codling moths (Laspyresia pomonella), sterile female moths are coated with particles comprising a slow-acting pesticide, for example a biocide comprising spores of a fungal entomopathogen. Males of the natural population attempting to mate with the females become contaminated with the pathogen, which they pass to the wild females in subsequent mating attempts before dying themselves.

### EXAMPLE 4

In a fourth embodiment of the present invention, sterile insects of a different species from the target species are used as carriers to deliver biocide. In this example, codling moths are the target species and medfly (Ceratitis capitata) are used as the sterile insect non-target carrier organisms. In this is example the medflies are already established pests in the area under treatment. The sterile medflies are exposed to particles comprising a biocide and codling moth female pheromone. The biocide is preferably selective for codling moths. Male codling moths seeking the source of the female pheromone will then encounter the biocide by coming into contact with the medflies or the surface on which they have been resting onto which particles comprising the biologically active agent have been shed. By this method, sterile insects are used to introduce a natural pathogen into a pest population and ensure its spread among said population.

### EXAMPLE 5

A fifth embodiment of the present invention uses a honeybee as the non-target carrier organism to control the parasitic mite, Varroa destructor, which is a severe predator of honeybees. The mites attach themselves to the bodies of foraging worker honeybees. The bees return to the hive carrying the mites which, once in the hive, parasitise the larval adult bees (the brood) in the comb. Methods in current use to control Varroa involve fumigation of the hive with selective pesticides, or introduction of miticidal compounds which permeate the hive and which achieve concentrations high enough to kill the mites without killing the honeybees. In all these methods there is a high risk to the bees, especially as the concentration of the introduced toxin must be increased, or potentially harmful synergists must be used, as time goes on to compensate for the evolution of resistance in the mites.

Accordingly, in this embodiment of the present invention, honeybees entering the hive are caused to pass through a chamber containing particles comprising thymol, which is a naturally-occurring essential oil. The returning honeybee foragers become contaminated with the particles and carry them into the hive on their bodies where they are passed onto the mites. The bees are able to remove the particulates from their bodies by their highly efficient grooming behaviour, but the mites having a protective dome shaped carapace are not able to articulate their legs or palps into such a position so as to be able to groom the particles off. The effect of the particles comprising thymol is to cause the mites to lose their grip on body of the honeybee, whereupon the mite falls to the bottom of the beehive and dies, being unable to feed from the honeybees. Furthermore, the particles comprising thymol act as a repellent to the Varroa mites, further causing them to detach and fall to the bottom of the beehive. Whilst the use of thymol in the control of Varroa is well-known to those skilled in the art, the mode of operation of the present invention is not known and overcomes the disadvantages associated with the traditional ways in which thymol is utilized.

Traditional thymol systems utilize much higher doses of thymol in order to be efficacious. Thymol, although a derivative of the essential oil Thyme Oil, carries a strong odor and use of very high doses can contaminate honey in the beehive, making it inedible. Moreover, traditional thymol products are placed in the hive which requires that the beehive be opened and causes the bees to be disturbed. In addition, traditional thymol products for Varroa control act in the vapour phase and the high concentration that needs to be achieved may result in bees being repelled from the beehive. The present invention overcomes the limitations of traditional thymol products as much lower doses of thymol can be utilized, because the particles comprising thymol come into direct contact with the Varroa and it is not necessary to achieve a high vapour pressure in the hive. Using the bees to deliver the particles comprising thymol means that the system is highly targeted and the beehive does not have to be opened.

### EXAMPLE 6

A sixth embodiment of the present invention involves applying herbicides to a plant surface. Certain herbicides act by penetrating the plant through the leaf surface. It is difficult to apply such herbicides in granular form to plants because the granules do not attach to the plant surface and are readily dislodged by wind or are leached off by rain or irrigation water. Insects may therefore be used to disseminate herbicides which may be associated with particles which will attach readily to both the insect body surface and the plant surface, both of which have similar physico-chemical properties; being waxy and hydrophobic. The most suitable insects for this method are those for which the weed is a foodplant, so that the insect will be naturally attracted to that plant.

### EXAMPLE 7

A seventh embodiment of the present invention involves transferring pollen to plants using insects such as bees. In this embodiment the bee will be exposed to a particle comprising pollen, wherein the bee will deliver the pollen to the target site. This method is advantageous when it is desired to increase the frequency of pollination or to ensure cross-pollination of a particular variety or cultivar. In this case it is preferred to use a natural pollinator as the non-target carrier organism. In the majority of cases this will be a honeybee or a solitary, subsocial or semisocial bee, such as a bumblebee. This embodiment provides the advantage that the pollen attached to the particle can be distributed at much higher levels than pollen on its own.

### EXAMPLE 8

In an eighth embodiment of the present invention contact insecticides, preferably those which are slow-acting, are transferred to a substrate such as a plant surface where they can act against a target insect or an arthropod pest. For example, Sharp-shooter bugs, which are pests of grapes, can be attracted into dispensers by visual features, such as yellow colour, wherein the particles comprising a slow-acting contact insecticide adhere to the Sharp-shooters. Alternatively, sharp-shooters may be exposed to the particles comprising a slow-acting contact insecticide in some other way. On returning to vines on which they feed, they transfer the said particles to the stems and leaves of the plants, where they will be picked up by other bugs, including other Sharp-shooters.

In this example, a pest which can be attracted to a dispenser comprising particles comprising a biocide may be used to deliver a very low dose of the biocide to a plant to control pests of that plant which cannot be so readily attracted to a dispenser, or in situations where it would be impractical or not possible to attract higher numbers of pests of the same species to such a dispenser. For example, the Sharp-shooter may be attracted to the dispenser using visual cues, but fewer will be attracted than is desirable for control, as there is presently no pheromone attractant suitable for the Sharp-shooter. Thus, those Sharp-shooters which are attracted are used to disseminate said particles to a wider number of the population to help effect control.

### EXAMPLE 9

The ninth embodiment of the present invention involves using insects to deliver anti-microbial or anti-fungal compounds to a plant or crop surface where they can act against a plant disease affecting the target plant or crop.

### EXAMPLE 10

Two embodiments of the present invention may be utilised together. For example a dispenser may be inserted into the entrance of a beehive, wherein the dispenser comprises particles comprising control agents to reduce Varroa in the beehive, and particles comprising pollen or a control agent to be delivered to plant organisms by foraging honeybees. The dispenser may, for example, comprise two chambers, each chamber containing one of the two different biologically active particles.

The honeybees may be encouraged, using behavioral and visual cues, to enter through the chamber containing the particle comprising a Varroa control agent, such as thymol, and to leave the beehive through the chamber containing particles comprising pollen or control agent for delivery to the plant organism. The Varroa control agent helps reduce the impact of the Varroa on the honeybee, and the pollen or second control agent is delivered to the target plant organisms whilst the honeybee is foraging.

1-28. (canceled)

29. A method of delivering a biologically active agent to a target site comprising exposing a surface of a non-target carrier organism to a carrier comprising at least one biologically active agent, wherein the non-target carrier organism delivers the biologically active agent to the target site,
wherein the non-target carrier organism is a bee and the target site is a parasite of a bee;
wherein the carrier is a particle and said particle releasably adheres to the non-target carrier organism; and
wherein the biologically active agent comprises a pesticide and/or a behaviour modifying agent.

30. The method as claimed in claim 29, wherein the non-target carrier organism is unable to mate and/or produce viable offspring.

31. The method as claimed in claim 29, wherein mating-disruption is caused by the non-target carrier organism due to the presence of a behaviour modifying chemical.

32. The method as claimed in claim 29, wherein pest control is caused by transference of the biologically active agent from the non-target carrier organism to the target site.

33. The method as claimed in claim 29, wherein the non-target carrier organism is sterile.

34. The method as claimed in claim 29, wherein the non-target carrier organism is exposed to the biologically active agent prior to egg hatch; during egg hatch; at any larval stage; pre, during, or post emergence from the pupa; or any combination thereof.

35. The method as claimed in claim 29, wherein the non-target carrier organism is exposed to the biologically active agent contained within a dispenser.

36. The method as claimed in claim 29, wherein the pesticide is selected from the group consisting of an insecticide, a chemosterilant, an anti-microbial agent, an acaricide, an ovicide, an insect growth regulator, a fungicide, a fungus, a virus, a bacterium, an essential oil, an anti-viral agents, a bacteriacides, and any combination thereof.

37. The method as claimed in claim 29, wherein the behaviour modifying chemical is selected from the group consisting of a semiochemical, an allelochemical, or a repellent, and any combination thereof.

38. The method as claimed in claim 29, wherein the particles have an average particle size diameter in the range of from 0.5 to 100 μm.

39. The method as claimed in claim 29, wherein the particle is a composite particle and comprises a core of inert substrate which is impregnated with and/or coated with the biologically active agent.

40. The method as claimed in claim 39, wherein the core comprises material selected from the group consisting of silicon dioxide, magnesium silicate, diatomeous earth, cellulose, wax, lipids, resins, ceramics, a natural or synthetic polymer, and any combination thereof.

41. The method as claimed in claim 29, wherein the particle comprises electrostatically charged materials or metallic materials.

42. The method as claimed in claim 29, wherein the particle comprises at least 0.01% by weight of biologically active agent, wherein the biologically active agent is not a semiochemical.

43. The method as claimed in claim 29, wherein the particle comprises least 0.1 femtograms of semiochemical per particle.

44. The method as claimed in claim 29, wherein the particle is transferred from the non-target carrier organism to the target site.
